(19) United States
(12) Patent Application Publication
(10) Pub. No.: US 2014/0163293 A1
(43) Pub. Date: Jun. 12, 2014

(54) PROCESS AND APPARATUS FOR ALKYLATION

(71) Applicants: UOP LLC, Des Plaines, IL (US); BORESKOV INSTITUTE OF CATALYSIS, SIBERIAN BRANCH, Novosibirsk (RU)

(72) Inventors: Daniel K. Aiken, Arlington Heights, IL (US); Kurt A. Detrick, Glen Ellyn, IL (US); Andrey Kuzmin, Novosibirsk (RU)

(73) Assignees: Boreskov Institute of Catalysis, Siberian Branch of Russian Academy of Sciences, Novosibirsk (RU); UOP LLC, Des Plaines, IL (US)

(21) Appl. No.: 13/709,575

(22) Filed: Dec. 10, 2012

(51) Int. Cl. B01D 17/02

(52) U.S. Cl. CPC B01D 17/0214
USPC 585/719; 585/800; 585/802; 422/187

(57) ABSTRACT

One exemplary embodiment can be a process. The process can include obtaining a hydrocarbon phase having one or more hydrocarbons and an alkylation catalyst from a first vessel, swirling the hydrocarbon phase to separate the alkylation catalyst, and recycling the alkylation catalyst to an alkylation reactor.

### FIELD OF THE INVENTION

This invention generally relates to a process and an apparatus for alkylation.

### DESCRIPTION OF THE RELATED ART

Typically, motor fuels are produced with sufficient octane to ensure the efficient and reliable operation of a motor vehicle. One process that can be used to improve motor fuel octane is an alkylation process. Generally, an alkylation process can combine light alkenes, which are usually mixtures of propene and butenes, with one or more alkanes, such as isobutane. The alkylation reaction generally takes place in the presence of a catalyst, which may include an acid, such as hydrofluoric or sulfuric acid, under conditions typically selected to maximize alkylate yield and quality. Usually, the product can possess anti-knock properties and high octane due to the presence of branched alkanes.

In such processes, the reaction product may form a suspension with an alkylation catalyst and be transferred to downstream equipment, typically a large vessel for separating the alkylation catalyst from the reaction product as well as any unreacted hydrocarbons. Usually, the reaction product is subsequently separated into various fractions often using one or more distillation towers.

Generally, the vessel or settler that is used to separate the acid phase from the hydrocarbon phase is designed for laminar flow conditions to minimize the entrainment or carryover of the acid phase in the hydrocarbon exiting the large vessel. For existing liquid acid alkylation units, feed capacity typically is limited by the downstream separation volume available. Exceeding this limit may result in acid carryover to downstream fractionation units, potentially risking increased corrosion.

Moreover, each unit volume increase in alkene feed to the unit typically corresponds to an eight-to-twelve fold increase in isoalkane flow to maintain optimum reaction conditions and product quality. This increased volumetric flow of isoalkanes to the large vessel with respect to the acid flow volume can increase the amount of liquid acid catalyst entrained in the hydrocarbon phase as it exits the vessel. This excess entrained acid carried to the fractionation section can accelerate equipment corrosion. Accelerated equipment corrosion may negatively impact the reliability and safety of the unit and increase shutdowns of the unit to repair the corrosion damage.

Increasing unit capacity often requires installing a larger vessel to minimize acid carryover to facilitate the higher feed rates. Alternatively, a parallel reactor-settler combination may be added in parallel to accommodate the increased flow. Unfortunately, either option involves increased capital investment, such as greater acid and hydrocarbon inventories, and equipment down time to implement the modifications. Moreover, lowering inventories can improve safety by reducing the potential risk of system failures.

Thus, it would be desirable to provide a unit or process that minimizes the corrosion and wear of the downstream vessels due to alkylation catalyst carry over.

### SUMMARY OF THE INVENTION

One exemplary embodiment can be a process. The process can include obtaining a hydrocarbon phase having one or more hydrocarbons and an alkylation catalyst from a first vessel, swirling the hydrocarbon phase to separate the alkylation catalyst, and recycling the alkylation catalyst to an alkylation reactor.

Another exemplary embodiment may be an apparatus for alkylation. The apparatus may include at least one alkylation reactor containing an alkylation catalyst and communicating with at least one cooler, a settler communicating with the at least one alkylation reactor, and a vortex separator communicating with the settler to receive a hydrocarbon phase. The vortex separator may include a member formed about a perimeter of an interior space and having a first side and a second side forming a passageway for communicating the hydrocarbon phase from an outer surface of the member to the interior space, and a frustum positioned proximate to the passageway for separating the alkylation catalyst.

A further exemplary embodiment can be a process that may include providing one or more hydrocarbons and an alkylation catalyst to at least one alkylation reactor, providing an alkylation effluent from the at least one alkylation reactor to a settler for providing a volume for allowing the separation and containment of a hydrocarbon phase and an acid phase, sending at least a portion of the hydrocarbon phase to a vortex separator, separating the one or more hydrocarbons from the alkylation catalyst in the vortex separator, and sending the one or more hydrocarbons from the vortex separator to a fractionation zone. The vortex separator can include a member formed about a perimeter of an interior space and having a first side and a second side forming a passageway for communicating the hydrocarbon phase from an outer surface of the member to the interior space, and a funnical frustum positioned proximate to the passageway.

By using vortex contacting for the coalescing of the entrained acid phase from the hydrocarbon phase in a single smaller vessel in series with an existing settler, a significant reduction in overall vessel size, equipment, and hydrocarbon and acid inventories can be achieved as compared to either designing a new parallel reactor-settler section or revamping an existing unit with a new larger settler vessel. Usually, the hydrocarbon phase with entrained acid is tangentially introduced into a contoured circular surface at high angular velocities in a rotating liquid cylinder before exiting the vortex separator. The rotating hydrocarbon is subjected to high g-forces that can improve the coalescing and separation of the entrained acid from the hydrocarbon phase along the inner wall of the device. The coalesced acid may leave as a separated heavy phase and the hydrocarbon can exit as a light phase from the device with a substantially reduced entrained acid content.

### DEFINITIONS

As used herein, the term “stream” can include various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules. Furthermore, a superscript “+” or “−” may be used with an abbreviated one or more hydrocarbons notation, e.g., C3⁺ or C3⁻, which is inclusive of the abbreviated one or more hydrocarbons. As an example, the abbreviation “C3⁺” means one or more hydrocarbon molecules of three carbon atoms and/or more. The stream may include substances in addition to or other than one or more hydrocarbons, such as an alkali, an acid and/or water.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “rich” can mean an amount of generally at least about 50%, and preferably about 70%, by mole, of a compound or class of compounds in a stream. If referring to a solute in solution, e.g., one or more thiol compounds in an alkaline solution, the term “rich” may be referenced to the equilibrium concentration of the solute. As an example, about 5%, by mole, of a solute in a solvent may be considered rich if the concentration of solute at equilibrium is 10%, by mole.

As used herein, the term “substantially” can mean an amount of generally at least about 80%, preferably about 90%, and optimally about 99%, by mole, of a compound or class of compounds in a stream. If referring to a solute in solution, e.g., one or more thiol compounds in an alkaline solution, the term “substantially” may be referenced to the equilibrium concentration of the solute. As an example, about 8%, by mole, of a solute in a solvent may be considered substantial if the concentration of solute at equilibrium is 10%, by mole.

As used herein, the term “frustum” can mean a solid figure formed when a plane, which is substantially parallel to a base or a top of a cone, a pyramid, and a funnel, sections the shape. With respect to the term “funnical frustum”, the sectioning plane can pass through a conical portion of the funnel and be substantially parallel to another plane perpendicular to the mouth of the funnel.

As used herein, the term “coupled” can mean two items, directly or indirectly, joined, fastened, associated, connected, or formed integrally together either by chemical or mechanical means, by processes including stamping, molding, or welding. What is more, two items can be coupled by the use of a third component such as a mechanical fastener, e.g., a screw, a nail, a staple, or a rivet; an adhesive; or a solder.

As used herein, the term “g-force” can be abbreviated “g” and mean the angular momentum imparted to a liquid and can be in units of meter per second squared (abbreviated m/s²). One “g” can equal 9.8 m/s².

As used herein, the term “alkylate” can mean a product of alkylation that is generally a branched-chain alkane derived from an isoalkane and an alkene.

As used herein, the specified alkenes can include their isomers. As an example, the term “butene” can include 2-methylpropene, 1-butene, and 2-butene. Similarly, alkenes such as pentene and hexene can include their respective isomers as well.

As used herein, the term “kilopascal” may be abbreviated “KPa” and all pressures disclosed herein are absolute.

As used herein, the term “vapor” can mean a gas or a dispersion that may include or consist of one or more hydrocarbons.

As used herein, the term “immiscible” can describe substances of the same phase or state of matter that cannot be uniformly mixed or blended. As an example, such immiscible mixtures can include liquids such as oil and water; a caustic solution, such as a water solution of sodium hydroxide, and hydrocarbon; or a solution of water and acid or anhydrous acid and hydrocarbon.

As depicted, process flow lines in the figures can be referred to interchangeably as, e.g., lines, pipes, feeds, products, alkylation catalyst, phases, or streams.

### BRIEF DESCRIPTION OF THE DRAWINGS

FIG. 1 is a schematic depiction of an exemplary apparatus with one vessel schematically depicted in cross-section to reveal two liquid phases.

FIG. 2 is a cross-sectional, elevational view of a vessel.

FIG. 3 is a cross-sectional plan view of a member.

FIG. 4 is an enlarged, cross-sectional view of a part of the member as depicted in FIG. 3.

### DETAILED DESCRIPTION

Generally, the embodiments disclosed herein pertain to an alkylation unit and a process. The alkylation process can be carried out either as a batch or continuous operation, although it is generally preferable to carry out the process continuously. In continuous operations, reactants along with the alkylation catalyst can be maintained at sufficient pressures and temperatures in a liquid phase and then continuously forced through dispersion devices into at least one alkylation reaction zone. The dispersion devices can be one or more jets, nozzles, porous thimbles or static mixers that can optionally create a turbulent flow. After a sufficient period of time, the alkylation product can be continuously separated from the catalyst and the alkylation catalyst may be separated and recycled to the at least one alkylation reaction zone. Optionally, at least a portion of a hydrogen fluoride catalyst can be continuously regenerated and returned to the at least one alkylation reaction zone. Exemplary alkylation units and processes suitable for application of the mechanisms and devices discussed herein are disclosed in, e.g., U.S. Pat. No. 5,098,668 and U.S. Pat. No. 6,303,843 B1.

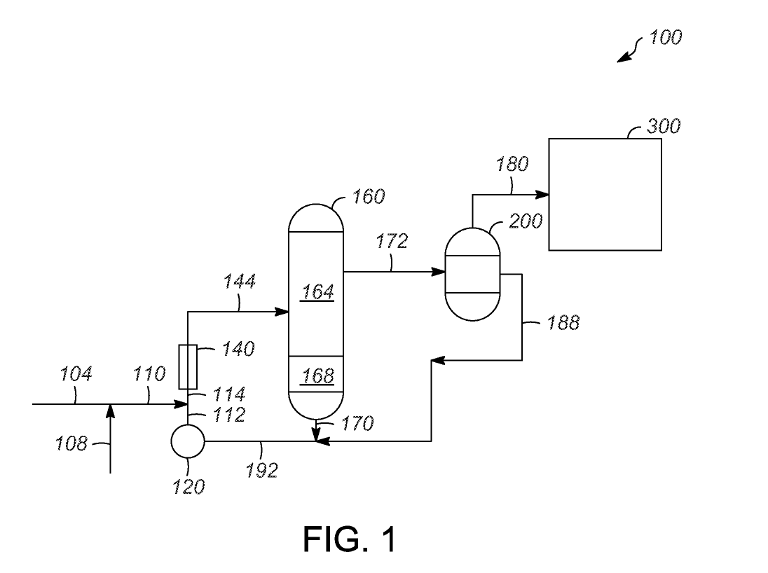

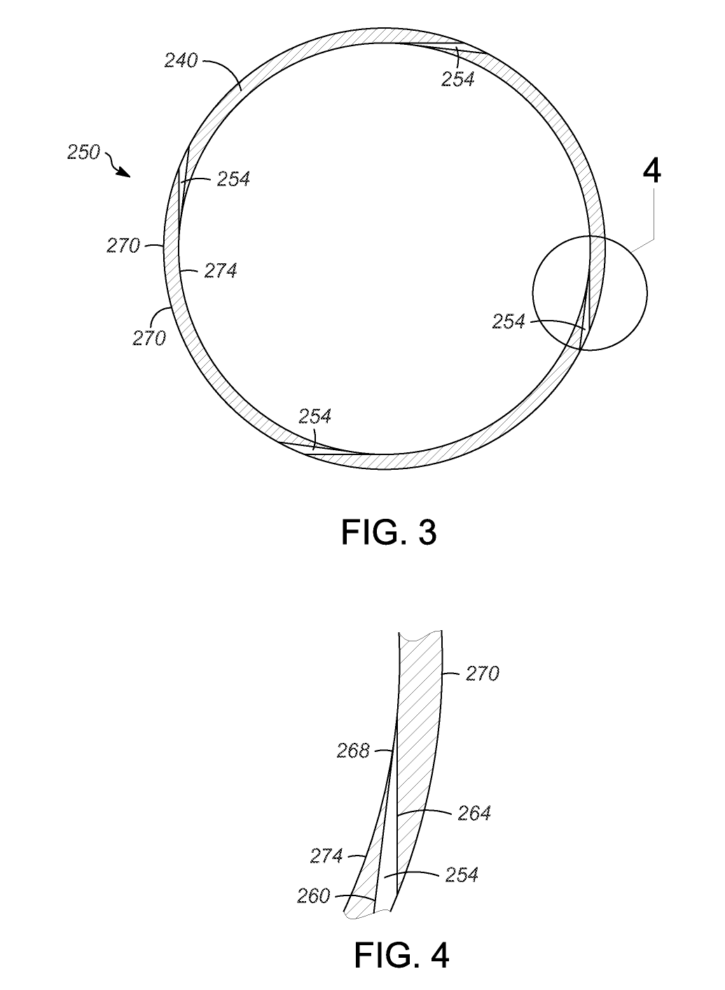

Referring to FIGS. 1-4, one exemplary apparatus 100 can include at least one cooler 120, at least one alkylation reactor 140, a first vessel or settler 160, a second vessel or vortex separator 200, and a fractionation zone 300. Although the at least one cooler 120 is depicted separately from the at least one alkylation reactor 140, it is contemplated that the cooler 120 can be incorporated into a reactor of an alkylation zone, such as coupling a water jacket to an alkylation reactor to control the heat of reaction. Furthermore, in other exemplary apparatuses, the cooler 120 can be omitted.

An alkene feed 104 and an alkane feed 108 can be combined to form a combined hydrocarbon feed 110 including one or more C3-C5 hydrocarbons. Generally, the alkene feed 104 includes one or more C3-C5 alkenes, typically butene, and the alkane feed 108 includes one or more C3-C5 alkanes, typically butane. In other forms of hydrogen fluoride alkylation, such as hydrogen fluoride detergent alkylation, the combined hydrocarbon feed 110 may include benzene and one or more C10-C14 alkenes. Alternatively, the combined hydrocarbon feed 110 may omit one or more alkenes.

The alkylation catalyst can include a hydrogen fluoride, a hydrogen chloride, a hydrogen bromide, or a mixture thereof. The alkylation catalyst can be in anhydrous form or an acid solution that may include a small amount of water. Preferably, the alkylation catalyst is hydrogen fluoride. Typically, the amount of water present in the hydrogen fluoride and water solution is no more than about 30%, preferably less than about 10%, and more preferably less than about 5%, based on the total weight of the solution. In another exemplary embodiment, the alkylation catalyst can include sulfuric acid instead of other acids and the combined hydrocarbon feed 110 may omit the one or more alkenes. An exemplary method using sulfuric acid is disclosed in, e.g., U.S. Pat. No. 7,126,038. As described hereinafter, the alkylation catalyst is hydrofluoric acid, although it should be understood that any suitable alkylation catalyst may be utilized. The alkylation catalyst may be provided as a cooled acid feed 112 and added to the combined hydrocarbon feed 110 to form a combined feed 114.

Generally, the combined feed 114 includes two phases, namely a hydrocarbon phase and an alkylation catalyst or acid phase. The feed can include about 10-about 60%, by volume, of the hydrocarbon phase and about 40-about 90%, by volume, of the alkylation catalyst phase, based on the total volume of the feed. Typically, the hydrocarbon phase includes one or more hydrocarbons, such as a combination of one or more alkenes and one or more isoalkanes. Usually, the isoalkane to alkene molar ratio is about 2:1-about 25:1, preferably about 5:1-about 20:1. The hydrocarbon phase can include other compounds, such as normal alkanes, e.g., normal ethane, propane, and butane, in amounts of generally less than about 20%, by volume.

The combined feed 114 may be provided to the at least one alkylation reactor 140.

The at least one alkylation reactor 140 may include a single reactor, or two or more reactors either in parallel or series. In the instance of multiple reactors, the combined hydrocarbon feed 110 and the cooled acid feed 112 can be split and blended to form respective combined feeds 114 for the respective reactors. Although the at least one alkylation reactor 140 is depicted as a vessel having a greater diameter than the associated piping, it should be understood that the alkylation reactor 140 can be fashioned to be the same diameter as the associated piping or any other suitable diameter. Generally, the alkylation reaction temperature can range from about −20-about 70° C., preferably about −5-about 55° C. Typically, the reaction occurs in a liquid phase at a pressure of about 380-about 1,200 KPa.

An alkylation effluent 144 exiting the at least one reactor 140 can include one or more hydrocarbons and the hydrofluoric acid. The one or more hydrocarbons can include one or more C4⁺ hydrocarbons, usually one or more C8⁺ alkylated hydrocarbons. Thus, the alkylation effluent 144 may include propane, normal butane, isobutane, and an alkylate product of C7 and/or C8 isoalkanes, such as trimethylpentanes and dimethylhexanes. The volumetric ratio of hydrofluoric acid to hydrocarbons in the alkyation effluent 144 can range from about 0.25:1-about 10:1. The one or more hydrocarbons can form a suspension and be sent to the settler 160.

The settler 160 can operate at a temperature of about −20-about 125° C., preferably about 0-about 80° C. and a pressure of about 50-about 3,100 KPa, preferably about 95-about 2,600 KPa. The settler 160 can be orientated horizontally or vertically, and can optionally contain at least one of one or more trays and a vapor phase. Generally, the one or more hydrocarbons and the hydrofluoric acid in the settler 160 form two phases via gravity, namely a lighter hydrocarbon phase 164, including one or more hydrocarbons, and a heavier acid phase 168. The heavier acid phase 168 can settle in the bottom of the settler 160 and be withdrawn as an acid phase stream 170. The acid phase stream 170 may be combined with an alkylation catalyst stream 188 to form a combined acid stream 192. The combined acid stream 192 may be passed to the at least one cooler 120 for recycling to the at least one alkylation reactor 140.

The at least one cooler 120 can include one cooler or several coolers in parallel or series. Generally, the at least one cooler 120 is a heat exchanger utilizing cooling water to reduce the temperature of the acid catalyst. Thus, the at least one cooler 120 can receive the hydrofluoric acid from the settler 160 and recycle the cooled acid to the alkylation reactor 140 for catalyzing reactions. Hence, the at least one cooler 120 can aid in controlling the reaction rate.

The lighter hydrocarbon phase 164 can be withdrawn as a hydrocarbon phase through a line 172 and sent to the second vessel 200. Although only one vessel 200 is depicted, multiple vessels in series or parallel may be used. The second vessel 200 can be a vortex separator, and such vortex separators are disclosed in, e.g., U.S. application Ser. Nos. 13/709,329 and 13/709,376, both by Kuzmin et al., filed herewith, and assigned attorney docket numbers H0034733-8285 and H0034733-01-8285, which are hereby incorporated by reference in their entirety.

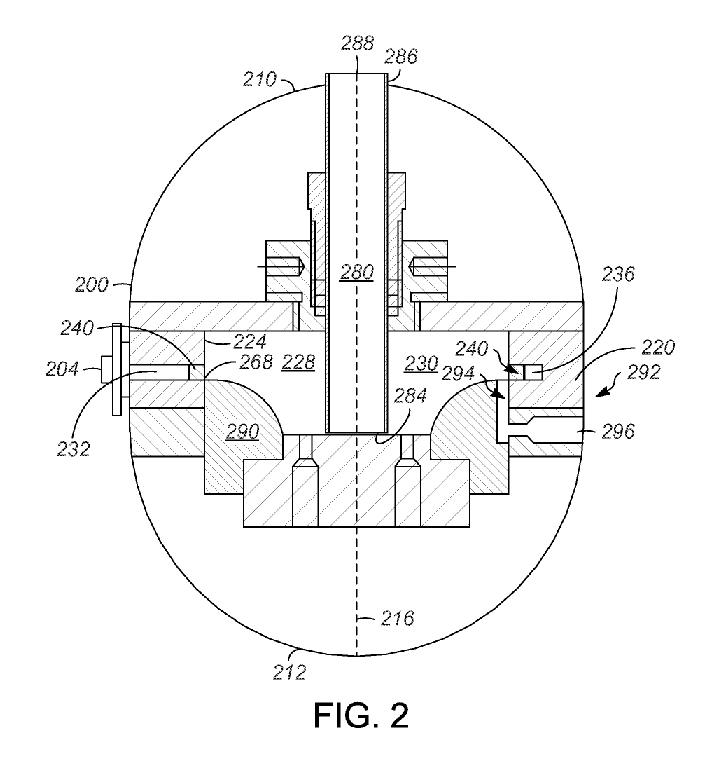

As shown in FIG. 2, the second vessel 200 having a top 210 and a bottom 212 may include at least one wall 220, an inlet 204, a vortex zone 230 defined by a perimeter 224, a member 240, a tube 280, and a frustum 290. The at least one wall 220 can define an interior space 228. The member 240 can be a swirler, and optionally substantially ring-shaped formed about the perimeter 224 of the interior space 228.

The second vessel 200 can only contain a single zone, namely the vortex zone 230 to facilitate the formation of a vortex of swirling liquids. The hydrocarbon phase 164 can be provided through the inlet 204, enter a passageway 232 formed by the at least one wall 220, and flow into a circular chamber 236 adjacent to the member 240. Typically, hydrocarbons can still have some hydrofluoric acid present. Entering the member 240, which can be formed by the at least one wall 220 or be a separate integral component, can swirl the hydrocarbon phase 164.

Referring to FIGS. 2-4, the member 240 can be positioned within the interior space 228 and abut the at least one wall 220 and reside downstream and at the edge of the frustum 290, typically funnical. The funnical frustum 290 can form a curvature for facilitating the formation of a vortex. At least a portion of its curvature can resemble parabola. Although a parabolic profile is depicted other suitable profiles can include a rectangular, a conical, or a concave profile. Generally, the member 240 can form a plurality 250 of passageways 254 to allow the hydrocarbon phase 164 to enter and travel from an outer surface 270 to an inner surface 274. Usually, each passageway 254 can taper from the outer surface 270 to the inner surface 274. Often, the member 240 can impart a swirl to the hydrocarbon phase 164 passing to the interior space 228.

Referring to FIG. 4, each passageway 254 can be defined by a first side 260 spaced apart from a second side 264 that tapers each passageway 254 to form a substantially rectangular slot 268. Thus, a swirl can be imparted to the hydrocarbon phase 164 entering the top of the member 240, passing into each passageway 254 and exiting the slot 268 formed in the inner surface 274 of the member 240.

Alternatively, the first side 260 can form vanes at an angle of about 90-about 180° with respect to one another that can further taper the passageway 254. As an aside, each side 260 and 264 can, independently, be considered a vane. The tapering of the passageway 254 can facilitate accelerating and imparting a circular motion to the first and second liquids. The sides 260 and 264 can be formed integrally with the member 240, or formed as separate components and coupled together to at least partially comprise the member 240.

In this exemplary embodiment, the hydrocarbon phase 164 can be pressurized to exit the slot 268 and swirl at about 10-about 60 g within the vortex zone 230, although the g-force can vary depending on the location, e.g., the passageway 254, and may exceed 60 g. This higher acceleration of the liquids can enhance separation so that any alkylation catalyst entrained within the hydrocarbon phase can separate.

Although not wanting to be bound by theory, the rotational movement of the liquid may be accelerated by means of a curved internal structure that may enable the heavier alkylation catalyst to move rapidly toward the vortex separator walls. Moreover, the frustum can maintain the stability of the vortex and smoothing of pressure and flow. The curved internal structure may include the frustum, preferably parabolic, that may abut the internal wall and taper the inner radius of the interior space 228.

The funnical frustum 290 can be positioned proximate and downstream to the member 240 and abutting the at least one wall 220. It should be understood, that the at least one wall 220 and the funnical frustum 290 can be formed as separate pieces and coupled together, or formed integrally together. The funnical frustum 290 can form a curvature for facilitating the formation of a vortex. Generally, the cross-section of the funnical frustum 290 can resemble any suitable bell curve.

The hydrocarbon phase 164, substantially absent alkylation catalyst, can enter a tube 280 positioned about a center 216 and extending past the top 210. The hydrocarbon phase 164 can enter via a first end 284 and exit via a second end 286 through a first outlet 288 to provide a one or more hydrocarbons stream 180, including alkylated hydrocarbons, such as one or more C6⁺ hydrocarbons, preferably one or more C8 hydrocarbons. The one or more hydrocarbons stream 180 can be provided to a fractionation zone 300 for providing one or more products, such as alkylate and one or more C5⁻ hydrocarbons, which may optionally be recycled to the combined hydrocarbon feed 110. The fractionation zone 300 can include any suitable equipment for separating the one or more hydrocarbons stream 180 into various fractions. Preferably, the fractionation zone 300 can utilize overhead condensers, pumps, furnaces, reboilers, and at least one, preferably a plurality of distillation columns. Moreover, the distillation columns in the fractionation zone 300 can operate at any suitable temperature and pressure to separate the one or more hydrocarbons into various hydrocarbon products.

The separated alkylation catalyst can be thrust against the perimeter 224, preferably circular or a periphery, coalesce to form larger droplets, and can exit a second outlet 292 formed by the at least one wall 220 and the frustum 290 to include a substantially vertical chamber 294 communicating with a substantially horizontal chamber 296. The alkylation catalyst stream 188 can be combined with acid phase stream 170, as discussed above, and provided to the at least one cooler 120 for use in additional alkylation reactions.

Although the embodiments disclosed herein depict a horizontally orientated vortex zone with a tube providing an outlet for a hydrocarbon stream, other orientations are also suitable. One exemplary embodiment can have a vertically orientated vortex zone with a hydrocarbon stream exiting from the bottom, as disclosed by, e.g., U.S. application Ser. No. 13/709,509, by Sattar et al., filed herewith, and assigned attorney docket number H0033521-8285, which is hereby incorporated by reference in its entirety.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A process, comprising:
A) obtaining a hydrocarbon phase comprising one or more hydrocarbons and an alkylation catalyst from a first vessel;
B) passing the hydrocarbon phase through a plurality of tapered passageways for communicating the hydrocarbon phase to an interior space of a vortex separator;
C) swirling the hydrocarbon phase to separate the alkylation catalyst; and
D) recycling the alkylation catalyst to an alkylation reactor.

2. The process according to claim 1, wherein the alkylation catalyst comprises hydrogen fluoride, sulfuric acid, or an acid solution thereof.

3. The process according to claim 1, further comprising recycling the alkylation catalyst to at least one cooler prior to entering the alkylation reactor.

4. The process according to claim 1, further comprising separating the one or more hydrocarbons after swirling and providing the one or more hydrocarbons to a fractionation zone.

5. The process according to claim 1, wherein the first vessel comprises a settler containing the hydrocarbon phase and an acid phase.

6. The process according to claim 5, further comprising withdrawing the acid phase and combining with the separated alkylation catalyst prior to recycling to the alkylation reactor.

7. The process according to claim 1, further comprising providing the hydrocarbon phase to a second vessel for swirling.

8. The process according to claim 7, wherein the second vessel comprises a vortex separator.

9. The process according to claim 8, wherein the vortex separator comprises a member forming a perimeter about an interior space and comprising a first side and a second side forming a tapered passageway communicating the hydrocarbon phase from an outer surface of the member to the interior space, and a funnical frustum positioned proximate to the passageway for separating the alkylation catalyst.

10. The process according to claim 9, wherein the funnical frustum is positioned downstream of the tapered passageway.

11-16. (canceled)

17. A process, comprising:
A) providing one or more hydrocarbons and an alkylation catalyst to at least one alkylation reactor;
B) providing an alkylation effluent from the at least one alkylation reactor to a settler for providing a volume for allowing the separation and containment of a hydrocarbon phase and an acid phase;
C) sending at least a portion of the hydrocarbon phase to a vortex separator, wherein the vortex separator comprises:
1) a member formed about a perimeter of an interior space and comprising a first side and a second side forming a tapered passageway for communicating the hydrocarbon phase from an outer surface of the member to the interior space; and
2) a funnical frustum positioned proximate to the passageway;
D) separating the one or more hydrocarbons from the alkylation catalyst in the vortex separator, wherein the separation comprises accelerating and swirling the hydrocarbon phase; and
E) sending the one or more hydrocarbons from the vortex separator to a fractionation zone.

18. The process according to claim 17, wherein the alkylation catalyst comprises hydrogen fluoride, sulfuric acid, or an acid solution thereof.

19. The process according to claim 17, wherein the one or more hydrocarbons comprises one or more C3-C5 hydrocarbons.

20. The process according to claim 17, wherein the first and second sides taper the passageway from the outer surface to an inner surface of the member.

21. (canceled)
